(19) United States
(12) Patent Application Publication
(10) Pub. No.: US 2009/0217256 A1
(43) Pub. Date: Aug. 27, 2009

(54) METHOD AND APPARATUS FOR UPDATING FIRMWARE IN PORTABLE TERMINAL

(75) Inventor: Song Kyoo KIM, Daegu Metropolitan City (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/372,372

(22) Filed: Feb. 17, 2009

(30) Foreign Application Priority Data
Feb. 22, 2008 (KR) 10-2008-0016271

(51) Int. Cl. G06F 9/44; H04M 3/00

(52) U.S. Cl. 717/168; 455/418

(57) ABSTRACT

A method and apparatus for upgrading firmware in a portable terminal are provided. The method includes activating a firmware recovery engine of a first portable terminal when an error occurs during a firmware upgrading process, searching, by the first portable terminal whose firmware recovery engine is activated, for a second portable terminal comprising the same firmware version as the first portable terminal, requesting, by the first portable terminal, a firmware recovery file to recover the firmware error from the second portable terminal, transmitting the firmware recovery file from the second portable terminal receiving the request of the firmware recovery file to the first portable terminal, and recovering the firmware in the first portable terminal, by using the received firmware recovery file.

### PRIORITY

This application claims the benefit under 35 U.S.C. § 119(a) of a Korean patent application filed on Feb. 22, 2008 in the Korean Intellectual Property Office and assigned Serial No. 10-2008-0016271, the entire disclosure of which is hereby incorporated by reference.

### BACKGROUND OF THE INVENTION

1. Field of the Invention

The present invention relates to firmware upgrade technology. More particularly, the present invention relates to an apparatus and method for upgrading firmware in a first portable terminal when a firmware upgrade error occurs at the first portable terminal.

2. Description of the Related Art

In general, portable terminals are controlled by firmware installed thereon. Firmware refers to a program that controls hardware when portable terminals are operated. If a new portable terminal is released with firmware installed thereon, the firmware may be continuously developed and debugged to provide new firmware versions through which performance of the portable terminal can be stabilized. If firmware of the portable terminal is developed with a new firmware version, the portable terminal needs to upgrade with the new firmware version. Accordingly, various methods, such as wired/wireless communication, can be used. In recent years, a wireless communication upgrading method, for example, a Firmware Over-The-Air (FOTA) service, has been recognized for upgrading firmware in portable terminals.

The FOTA service is a service that compares the existing firmware of a portable terminal with the latest available firmware and provides a delta file to a wireless network of only different portions, extracted from the firmware comparison. Thereby, the firmware is upgraded. That is, a portable terminal acquires a delta file through various communication networks in wired/wireless communication and corrects only the portion that is different from the existing firmware, i.e., corresponding to the delta file. Accordingly, the firmware upgrade is completed.

However, the conventional method for upgrading firmware in a portable terminal using a delta file has disadvantages in that, if the delta file has an unknown error, an error occurs entirely in the upgraded firmware. That is, the conventional firmware upgrade method makes it impossible to operate the upgraded firmware. As a result, the portable terminal user must visit a repair center to recover the firmware of the portable terminal.

Therefore a need exists for a method and apparatus for updating firmware in a portable terminal when an error occurs at the portable terminal.

### SUMMARY OF THE INVENTION

An aspect of the present invention is to address at least the above-mentioned problems and/or disadvantage and to provide at least the advantages described below. Accordingly, an aspect of the present invention is to provide an apparatus and method for upgrading firmware in a first portable terminal by receiving necessary files for firmware recovery from a second portable terminal through short-range wireless communication and recovering the firmware, when a firmware upgrade fails in the first portable terminal due to an unexpected error.

In accordance with an aspect of the present invention, a method for upgrading firmware in a portable terminal using a delta file is provided. The method includes activating a firmware recovery engine of a first portable terminal when an error occurs during a firmware upgrading process, searching, by the first portable terminal whose firmware recovery engine is activated, for a second portable terminal that includes the same firmware version as the first portable terminal, requesting, by the first portable terminal, a firmware recovery file to recover the firmware error from the second portable terminal, transmitting the firmware recovery file from the second portable terminal receiving the request of the firmware recovery file to the first portable terminal, and recovering the firmware in the first portable terminal, by using the received firmware recovery file.

In accordance with another aspect of the present invention, an apparatus for upgrading firmware in a portable terminal using a delta file is provided. The apparatus includes a firmware recovery engine for recovering the firmware when an error occurs during the firmware upgrading process, a controller for controlling activation of the firmware recovery engine according to whether the error occurs, and a short-range wireless communication unit for establishing a wireless communication channel with a second portable terminal, comprising a same firmware version as the portable terminal, and for receiving a firmware recovery file from the second portable terminal to recover the firmware in which the error has occurred.

Other aspects, advantages and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a schematic view illustrating a system for updating firmware according to an exemplary embodiment of the present invention;

FIG. 2 is a schematic block diagram illustrating a portable terminal according to an exemplary embodiment of the present invention; and

FIG. 3 is a flowchart describing a method for recovering firmware in a portable terminal according to an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms or words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Although a portable terminal according to an exemplary embodiment of the present invention is described based on a mobile communication terminal, the present invention is not limited thereto. Accordingly, the portable terminal may receive delta files using wired or wireless communication to upgrade the portable terminal's firmware and may perform short-range wireless communication. It will be appreciated that the portable terminal, according to an exemplary embodiment of the present invention, may include any information communication device, multimedia device and their applications, such as, a mobile communication terminal, a mobile phone, a Personal Digital Assistant (PDA) terminal, a smart phone, an International Mobile Telecommunication 2000 (IMT-2000) terminal, a Code Division Multiple Access (CDMA) terminal, a Wideband Code Division Multiple Access (WCDMA) terminal, a Global System for Mobile (GSM) communication terminal, a General Packet Radio Service (GPRS) terminal, an Enhanced Data GSM Environment (EDGE) terminal, a Universal Mobile Telecommunication Service (UMTS) terminal, a digital broadcasting terminal and the like.

In the following description, a delta file refers to a file that is generated by different portions that are extracted from a comparison result between an existing firmware version and a latest firmware version. The delta file includes firmware data and address information. The firmware data refers to data that are generated by the different portions between the latest firmware version and the existing firmware version. The address information refers to values of memory addresses to which the firmware data are intended to be installed.

A firmware version that a portable terminal has used before the firmware was upgraded refers to a same firmware version.

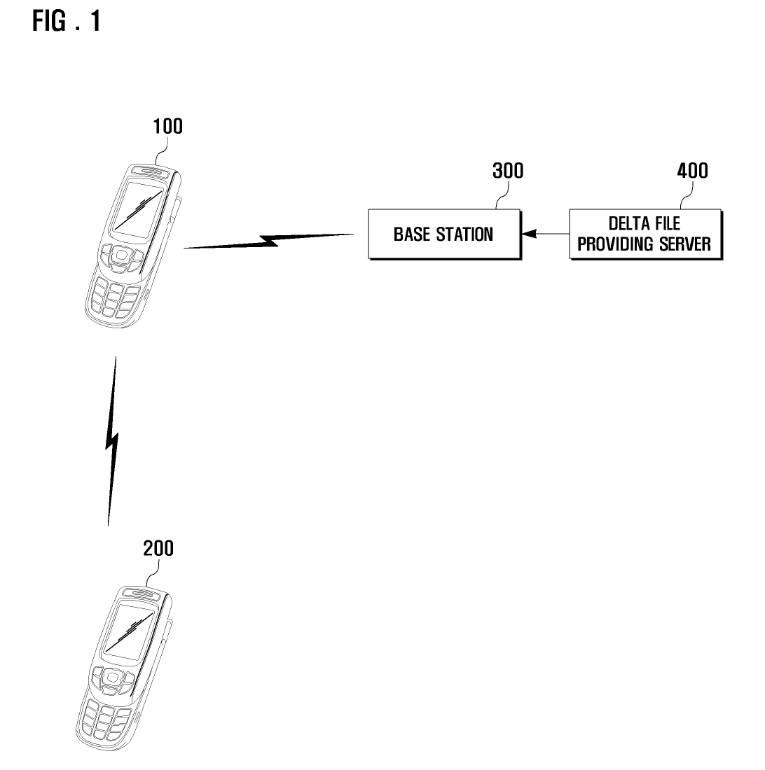

FIG. 1 is a schematic view illustrating a system for updating firmware according to an exemplary embodiment of the present invention.

Referring to FIG. 1, the firmware updating system includes a first portable terminal 100, a second portable terminal 200, a base station 300 and a delta file providing server 400.

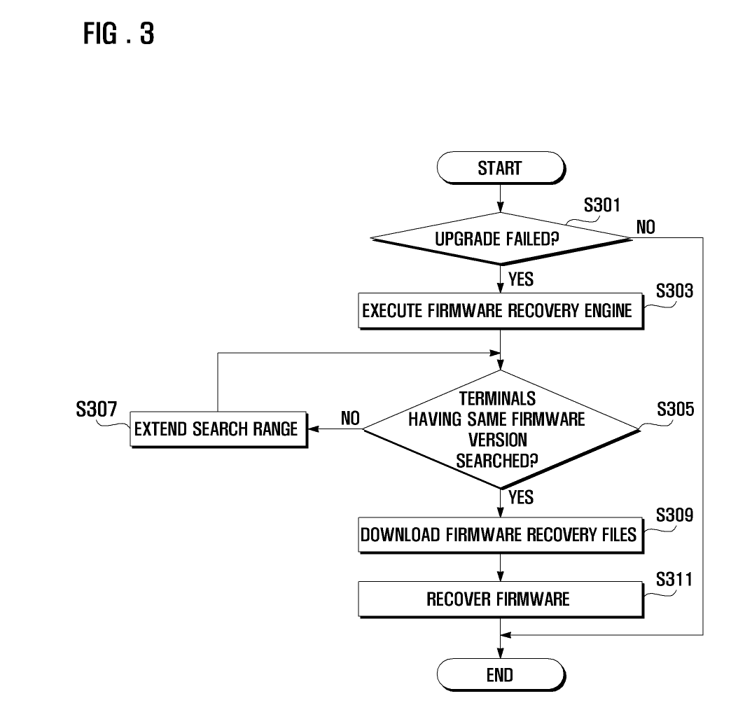

The first portable terminal 100 may perform firmware upgrade and short-range wireless communication, such as Bluetooth, Zigbee, an infrared communication, an Ultra Wide Band (UWB) communication and the like. The first portable terminal 100 may receive data files, generated in the delta file providing server 400, from the base station 300. The first portable terminal 100 then updates its firmware. More particularly, when the first portable terminal 100 fails a firmware upgrade (update) due to an error occurrence, the first portable terminal 100 may activate a firmware recovery engine, which will be described later, receive a firmware recovery file from the second portable terminal 200 and recover the firmware where the error has occurred. An exemplary firmware recovery method will be described later, with reference to FIG. 3.

The second portable terminal 200 is similar to the first portable terminal 100 and has the same firmware version as the first portable terminal 100. The second portable terminal 200 may establish a short-range wireless communication channel with the first portable terminal 100. When the first portable terminal 100 requests files necessary for its firmware recovery from the second portable terminal 200, the second portable terminal 200 extracts files, which correspond to address information received from the first portable terminal 100, and transmits the files to the first portable terminal 100.

The base station 300 may establish a communication channel with the first portable terminal 100 and transmit a delta file, received from the delta file providing server 400, to the first portable terminal 100 through the communication channel.

The delta file providing server 400 is manufactured by the manufacturer of the portable terminal. When new firmware is developed, the delta file providing server 400 generates a delta file and transmits the delta file to a corresponding portable terminal through the base station 300.

Although the firmware upgrade system, as illustrated in FIG. 1, upgrades firmware using FOTA service, it should be understood that the present invention is not limited thereto. That is, the first portable terminal 100 may upgrade the firmware using a variety of methods. For example, the first portable terminal 100 may upgrade firmware from a delta file, downloaded in a computer PC, using a wired cable (for example, a USB). Also, a delta file may be downloaded in an external memory card (for example, an SD card, a T-flash card, etc.). The external memory card is installed to the first portable terminal and the first portable terminal upgrades the firmware from the delta file.

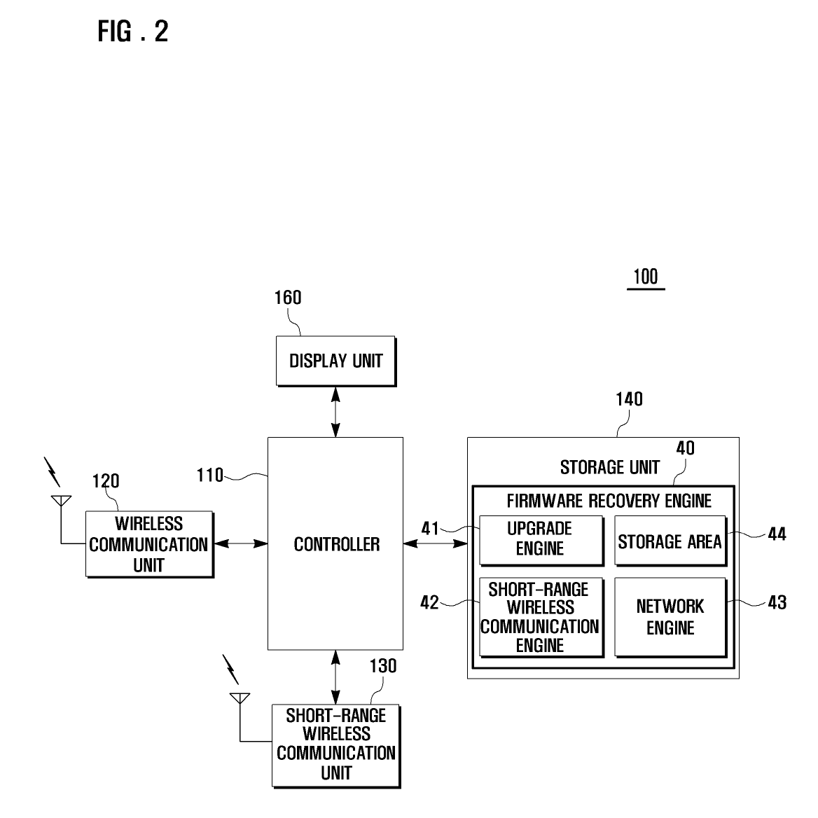

FIG. 2 is a schematic block diagram illustrating a first portable terminal 100 according to an exemplary embodiment of the present invention. Referring to FIG. 2, the first portable terminal 100 includes a controller 110, a wireless communication unit 120, a short-range wireless communication unit 130, a storage unit 140 and a display unit 160.

In order to perform data communication and a voice call between portable terminals, the wireless communication unit 120 establishes a communication channel with the base station and performs a voice call or data communication through the communication channel with an external portable terminal. The wireless communication unit 120 is configured to include a Radio Frequency (RF) transmitter (not illustrated) for up-converting the frequency of transmitted signals and amplifying the transmitted signals, and an RF receiver (not illustrated) for low-noise amplifying received RF signals and down-converting the frequency of the received RF signals. More particularly, the wireless communication unit 120 may receive a delta file from the base station in order to upgrade the firmware in the first portable terminal 100.

In an exemplary implementation, the short-range wireless communication unit 130 refers to a device that establishes a short-range wireless communication network with other portable terminals having a short-range wireless communication function. For example, the short-range wireless communication unit 130 may be achieved by a communication technology, such as Zigbee, wireless LAN, UWB, Home RF, Infrared Data Association (IRDA) and the like. More particularly, the short-range wireless communication unit 130 may establish a short-range wireless communication channel with a portable terminal (i.e., second portable terminal), having the same firmware version. Specifically, when a firmware upgrade fails in the first portable terminal 100, the short-range wireless communication unit 130 searches the second portable terminal using the firmware version information stored in a firmware recovery engine 40, which will be described later. The short-range wireless communication unit 130 establishes a short-range wireless communication channel with the second portable terminal. The firmware version information includes a model name of the portable terminal and a firmware version before upgrading in the portable terminal.

When the second portable terminal is searched, the short-range wireless communication unit 130 transmits the address information to the second portable terminal according to control of the firmware recovery engine 40. The short-range wireless communication unit 130 then receives a firmware recovery file that is generated as the second portable terminal and extracts files corresponding to the address information.

In an exemplary implementation, the storage unit 140 stores a program for controlling the entire operation of the first portable terminal 100, an Operating System (OS) for booting the first portable terminal 100 and application programs required for playing back multimedia contents. The storage unit 140 may store data generated as the first portable terminal 100 operates. That is, the storage unit 140 may store pictures, moving images, a phone book, audio data, corresponding contents, user data and the like.

More particularly, when an error occurs in the firmware of the portable terminal 100, the storage unit 140 may store a firmware recovery engine 40 that is activated to recover the firmware. The firmware recovery engine 40 may be stored in an area that is separated from an area in which the firmware is stored. Therefore, the firmware recovery engine 40 may not be damaged during the upgrade. The firmware recovery engine 40 may further include boot information so that the firmware recovery engine 40 may operate even in a state where the portable terminal may not be operated (or booted up).

The firmware recovery engine 40 includes an upgrade engine 41, a short-range wireless communication engine 42, a network engine 43 and a storage area 44.

The upgrade engine 41 receives the firmware recovery file and replaces the firmware recovery file with a corresponding address file, thereby recovering the firmware in the first portable terminal 100.

The short-range wireless communication engine 42 may establish a short-range wireless communication channel with the second portable terminal. For example, the short-range wireless communication engine 42 activates the short-range wireless communication unit 130 and searches for the second portable terminal using the firmware version information. That is, the short-range wireless communication engine 42 establishes a wireless communication channel with the second portable terminal 200 having the same firmware version information and receives the firmware recovery file from the second portable terminal 200.

When the second portable terminal is not searched in a communication range of the short-range wireless communication unit 130, the network engine 43 may be used to extend the search range. In an exemplary implementation, the network engine 43 may employ an ad hoc method. Unlike an infrastructure method where tens or hundreds of terminals limitedly form a network with respect to one hub, the ad hoc method is a method where respective terminals independently existing in space connect all devices within a radius that they may recognize and form a network. That is, each of the terminals may be a server, a hub or a client.

The network engine 43 forms a network with terminals near thereto, which may form an ad hoc network. The network engine 43 requests a search from nearby portable terminals of the second portable terminal 200, which includes the same firmware version information as the first portable terminal 100. Although the second portable terminal 200 is located outside the wireless communication range of the first portable terminal 100, the second portable terminal 200 may be searched.

The storage area 44 may store address information regarding the delta file, i.e., address information to request the firmware recovery file, and the version information, i.e., the firmware version information before upgrading.

The display unit 160 displays image data output according to the control of the controller 110. The display unit 160 may be implemented with a Liquid Crystal Display (LCD). It should be understood that the present invention is not limited thereto. When the display unit 160 is implemented with a touch screen, it may also serve as an input device. More particularly, the display unit 160 may display a message or an image showing that firmware is upgrading or recovering.

The controller 110 controls the entire operation of the first portable terminal 100, signal flows between blocks in the first portable terminal 100 and data processes. More particularly, the controller 110 may determine whether an error occurs during the firmware upgrade. The controller 110 executes the firmware recovery engine 40 to recover the firmware error. Before the controller 110 executes a firmware update, the controller 110 stores the firmware version information before upgrading and the address information in the storage area 44. The firmware version information is used to search the second portable terminal 200 that includes the same firmware version. The address information is transmitted to the second portable terminal 200 and used to extract the firmware recovery file.

Although it is not shown in the drawings, the first portable terminal 100 may be configured to further include units having add-on functions, such as a camera module, a broadcasting module, an audio signal output unit, such as a speaker, a voice signal input unit, such as a microphone, connecting terminals for exchanging data with external digital devices, a recharging terminal, a digital music source reproducing module, such as an MP3 module, and the like. With an increase of digital convergence, the first portable terminal 100 may further include other units that are equivalent to the above-listed units according to an exemplary embodiment of the present invention.

When a firmware upgrade error occurs in the first portable terminal 100, an exemplary firmware recovery method of the portable terminal 100 is explained with reference to FIG. 3. Although the present embodiment will exemplify a case where the firmware recovery method is automatically executed when a firmware upgrade error occurs in a portable terminal, it should be understood that the present invention is not limited thereto. For example, the portable terminal may be implemented to include a menu that assists a user to manually recover a former firmware version from a current firmware version.

FIG. 3 is a flowchart describing a method for recovering firmware in a portable terminal 100 according to an exemplary embodiment of the present invention.

Referring to FIG. 1 to FIG. 3, if a portable terminal manufacturer develops new firmware and provides a delta file, the first portable terminal 100 may receive the delta file from the base station 300 to upgrade its firmware. As described above, the first portable terminal 100 may acquire data files through various methods and upgrade its firmware. The delta file includes firmware data, generated only by portions that are different between the former firmware and the new firmware, and information of an address to which the firmware data are installed. That is, the controller 110 of the first portable terminal 100 replaces files at the address information with the firmware, thereby upgrading the firmware of the first portable terminal 100.

The controller 110 determines whether a firmware upgrade error occurs in the first portable terminal 100 in step S301. Examples of the firmware upgrade error include a case where the first portable terminal 100 is not booted after the firmware upgrade, a case where a particular application program is not normally operated and the like. When a firmware upgrade error does not occur in the first portable terminal 100 in step S301, the controller 110 terminates the firmware upgrade process. In contrast, when a firmware upgrade error occurs in the first portable terminal 100 in step S301, the controller 110 executes the firmware recovery engine 40 in step S303. The firmware recovery engine 40 may be stored in a protected area of the storage unit 140, i.e., an area that does not undergo upgrading, so that it may not be damaged when the firmware is upgraded. The firmware recovery engine 40 may include boot information so that it may operate even in a state where the portable terminal 100 may not be booted.

The controller 110 controls the firmware recovery engine 40 to store information regarding a firmware version before upgrading, which is hereinafter called a former version, and controls the address information in a storage area 44 of the firmware recovery engine 40. That is, the controller 110 stores the former firmware version before upgrading firmware and the address information in the storage area 44 using the delta file.

The short-range wireless communication engine 42 of the firmware recovery engine 40 activates the short-range wireless communication unit 130 and searches for another portable terminal that includes the same version, which is hereinafter called the second portable terminal in step S305. The short-range wireless communication unit 130 may be achieved by communication technology, such as Zigbee, a wireless LAN, an UWB, a Home RF, an Infrared Data Association (IRDA) and the like.

The method for searching the second portable terminal 200 is described in detail as follows. When the first portable terminal 100 broadcasts a message for requesting firmware version information to the other portable terminals, the portable terminals adjacent to the first portable terminal 100 receive the message and transmit their firmware version information to the first portable terminal 100. After receiving the firmware version information from the adjacent portable terminals, the first portable terminal 100 selects the second portable terminal 200 that includes the same firmware version and requests to establish a wireless communication channel to the second portable terminal 200. Alternatively, the first portable terminal 100 transmits its firmware version information to the second portable terminal 200. Accordingly, after receiving the firmware version information from the first portable terminal 100, the second portable terminal 200 compares the received firmware version information with its firmware version information. If the firmware version information is the same between the first portable terminal 100 and the second portable terminal 200, the second portable terminal 200 requests to establish a short-range wireless communication channel with the first portable terminal 100.

In contrast, if the second portable terminal 200 is not searched in step S305, the firmware recovery engine 40 activates the network engine 43 in step S307. The network engine 43 may use an ad hoc method. The network engine 43 transmits a network establishment request message and a message for requesting the search of the portable terminal 200 to the adjacent portable terminals, which may perform communication in an ad hoc method. The network engine 43 transmits through the short-range wireless communication unit 130 and extends the search range. The message for requesting the search of the second portable terminal 200 may include the former version. Although the present invention, as illustrated in FIG. 3, is implemented in such a way that steps S305 to S307 are repeated until the second portable terminal 200 having the same firmware version is searched, it should be understood that the present invention is not limited thereto. For example, the present invention may also be implemented in such a way that steps S305 to S307 are performed at a certain frequency or for a certain period of time. However, if it is determined that the portable terminal 200 may no longer be searched, the searching process is stopped and a result is reported to a user through a voice message or a pop-up message. The present invention may further include a process for measuring the search time period or a number of searches.

On the contrary, when the second portable terminal 200 is searched in step S305, the firmware recovery engine 40 downloads the firmware recovery file from the second portable terminal 200 in step S309. The firmware recovery engine 40 transmits to the second portable terminal 200 the address information stored in the storage area 44 through the short-range wireless communication unit 130. The second portable terminal 200 receiving the address information extracts files corresponding to the address information, i.e., the firmware recovery file, from its firmware and transmits the files to the first portable terminal 100.

The upgrade engine 41 replaces the files located at the address with the firmware recovery file received from the second portable terminal 200. Thereby, the firmware is recovered in step S311. Here, the upgrade engine 41 does not wait for the firmware recovery file to be completely transmitted. In contrast, if a file corresponding to one address is completely transmitted, the upgrade engine 41 replaces the transmitted file with the file located at the address. When the firmware recovery is completed in the first portable terminal 100, the firmware recovery engine 40 resets or reboots the first portable terminal 100.

As described above, the firmware updating method and apparatus according to an exemplary embodiment of the present invention may automatically recover firmware in a portable terminal through short-range wireless communication when firmware upgrading fulls due to the error occurrence. Therefore, problems existing in the portable terminal due to a firmware upgrade error are prevented.

The firmware upgrading method and apparatus, according to exemplary embodiments of the present invention, is not limited to the portable terminal. The firmware upgrading method and apparatus may be applied to all digital devices that use firmware and to technology related to a case where other software is upgraded.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for upgrading firmware in a portable terminal using a delta file, the method comprising:
activating a firmware recovery engine of a first portable terminal when an error occurs during a firmware upgrading process;
searching, by the first portable terminal whose firmware recovery engine is activated, for a second portable terminal comprising the same firmware version as the first portable terminal;
requesting, by the first portable terminal, a firmware recovery file to recover the firmware error from the second portable terminal;
transmitting the firmware recovery file from the second portable terminal receiving the request of the firmware recovery file to the first portable terminal; and
recovering the firmware in the first portable terminal, by using the received firmware recovery file.

2. The method of claim 1, wherein the firmware recovery engine stores firmware version information before firmware is upgraded and address information regarding the delta file.

3. The method of claim 1, wherein the searching for the second portable terminal comprises searching through short-range wireless communication.

4. The method of claim 3, wherein the short-range wireless communication comprises at least one of Bluetooth, Zigbee, a wireless LAN, an Ultra Wide Band (UWB), an Infrared Data Association (IRDA) and a Home Radio Frequency (Home RF).

5. The method of claim 3, wherein the searching for the second portable terminal comprises:
activating a network engine to extend a search range, if the second portable terminal is not searched in the range of the short-range wireless communication.

6. The method of claim 5, wherein the network engine uses an ad hoc method.

7. The method of claim 2, wherein the requesting of the firmware recovery file comprises transmitting address information regarding the delta file to the second portable terminal.

8. The method of claim 7, wherein the transmitting of the firmware recovery file comprises extracting files corresponding to the address information from the firmware of the second portable terminal.

9. The method of claim 1, wherein the searching for the second portable terminal comprises comparing firmware version information of the first portable terminal and firmware version information of the second portable terminal.

10. The method of claim 9, further comprising establishing a short-range wireless communication channel with the first portable terminal and the second portable terminal, if the firmware version information is the same between the first portable terminal and the second portable terminal.

11. The method of claim 1, further comprising rebooting the first portable terminal when firmware recovery is completed.

12. The method of claim 1, further comprising displaying a message or an image showing that firmware is recovering.

13. An apparatus for upgrading firmware in a portable terminal using a delta file, the apparatus comprising:
a firmware recovery engine for recovering the firmware when an error occurs during the firmware upgrading process;
a controller for controlling activation of the firmware recovery engine according to whether the error occurs; and
a short-range wireless communication unit for establishing a wireless communication channel with a second portable terminal comprising a same firmware version as a first portable terminal, and for receiving a firmware recovery file from the second portable terminal for recovering the firmware in which the error has occurred.

14. The apparatus of claim 13, wherein the short-range wireless communication unit uses at least one of Bluetooth, Zigbee, a wireless LAN, an Ultra Wide Band (UWB), an Infrared Data Association (IRDA) and a Home Radio Frequency (Home RF).

15. The apparatus of claim 13, wherein the firmware recovery engine comprises:
a storage area for storing address information regarding the delta file and firmware version information before the firmware is upgraded;
a short-range wireless communication engine for searching for the second portable terminal using the firmware version information, establishing a wireless communication channel with the second portable terminal, transmitting the address information and receiving the firmware recovery file;
an upgrade engine for installing the firmware recovery file received from the second portable terminal in a corresponding address; and
a network engine activated for extending a search range if the second portable terminal is not searched in the communication range of the short-range wireless communication unit.

16. The apparatus of claim 15, wherein the network engine uses an ad hoc method.

17. The apparatus of claim 13, wherein the firmware recovery engine is stored in an area separated from an area where the firmware is stored.

18. The apparatus of claim 13, wherein the firmware recovery engine further comprises boot information.

19. The apparatus of claim 18, wherein the firmware recover engine reboots the first portable terminal when the firmware recovery is completed.

20. The apparatus of claim 13, further comprising a display unit for displaying a message or an image showing that firmware is recovering according to control of the controller.
